(19) United States
(12) Patent Application Publication
(10) Pub. No.: US 2013/0076303 A1
(43) Pub. Date: Mar. 28, 2013

(54) BATTERY CHARGE CONTROL SYSTEM AND METHOD

(71) Applicants: Brian Beckham, Lincoln, NE (US); Jamie Jesse, Lincoln, NE (US)

(72) Inventors: Brian Beckham, Lincoln, NE (US); Jamie Jesse, Lincoln, NE (US)

(73) Assignee: LESTER ELECTRICAL OF NEBRASKA, INC., Lincoln, NE (US)

(21) Appl. No.: 13/625,860

(22) Filed: Sep. 24, 2012

Related U.S. Application Data
(60) Provisional application No. 61/538,849, filed on Sep. 24, 2011.

(51) Int. Cl. H02J 7/00

(52) U.S. Cl. 320/107; 320/161

(57) ABSTRACT

The present invention is a control system for charging a lead-acid battery based on the knowledge of the state of charge of the battery to provide a more consistent percent return target across the range of discharge levels and life of the battery.

### CROSS REFERENCE TO RELATED APPLICATIONS

This application claims priority to, and the benefit of, U.S. Application No. 61/538,849, filed Sep. 24, 2011, the specification of which is hereby incorporated by reference in its entirety.

### FIELD OF THE INVENTION

This invention relates generally to the field of battery chargers and battery charging systems.

### BACKGROUND OF THE INVENTION

The rechargeable batteries now used in present-day portable electronic equipment include those made from nickel-cadmium, lithium, lead-acid and metal hydrides. With such present-day rechargeable batteries, care must be taken not to over discharge the batteries during use. Otherwise, damage to the battery and/or the equipment may occur. For this reason, virtually all pieces of battery-operated portable electronic equipment include a monitoring circuit which operates to monitor the state of battery charge and to cut off the battery (i.e., interrupt the passage of current) once the charge drops below critical voltage.

Current practice is to overcharge such batteries, which include a number of cells, by a predetermined amount which is defined to be adequate to fully stir the electrolyte in the cell or cells which need the most stirring; that definition of the predetermined amount of overcharge is based on the assumption that the cell has been maximally discharged and that the cell has certain properties of age, condition and temperature.

At present, such monitoring circuits operate to determine the battery charge by sensing the magnitude of battery voltage. Once the battery voltage reaches a particular value (corresponding to the critical charge level), the battery is cut off. The cutoff battery voltage is typically set to provide a sufficient margin of safety so that the battery is cut off before any damage may be incurred. Unfortunately, battery voltage, under all conditions, is not a sufficiently sensitive measure of battery charge and for that reason the cutoff voltage is usually set high enough to assure that, under worst-case conditions, the battery will be cut off before the charge drops below the critical value. As a consequence, under normal conditions, the charge level may not fall below the critical level once the cutoff voltage is reached, thereby reducing the potential amount of energy that may be withdrawn from the battery.

It is known that the rate of change of the voltage in a lead acid battery is related directly to the condition of the charge of the battery. As the lead acid battery approaches a full charge, the rate of change in voltage slows and when that rate falls within a specified range for a period of time, this indicates the state of the charge. This principle is the basis for standard DV/DT termination, described in U.S. Pat. No. 3,794,905 and incorporated herein by reference. Standard DV/DT termination has the disadvantage of employing the same rate of change of voltage and time period across all discharge levels, resulting in an uneven percent return based upon the state of charge prior to the charge starting. The degree of uneven percent return depends on what discharge level is present in the battery versus the design parameter used to establish the amount and rate of voltage change in the charger.

### SUMMARY OF THE INVENTION

It is an object of the invention to provide for charging a lead acid battery with a more consistent percent return target across the range of discharge levels and life of the battery.

It is a further object of the invention to provide a charge termination which will adjust to accommodate variance in charge capabilities of a charger system.

It is a still further object of the invention to provide a charge termination method which is not dependent on knowledge of the temperature of the battery in order to hold a specific percent return ratio in the charge.

It is a still further object of the invention to provide a charge termination method that accommodates the stand loss of the batteries as well as the discharge amount without prior knowledge of the specific amount of either.

It is a still further object of the invention to provide a consistent return ratio across the life of the batteries.

In accordance with the above and further objects of the invention, the present invention provides an improved system and method for terminating the charge of a lead acid battery based on the state of charge of the battery. The system and method improve upon standard DV/DT termination by providing for the tailoring of DV and DT values based on the state of charge.

### BRIEF DESCRIPTION OF THE DRAWINGS

The following invention will be described with reference to the following drawings, of which:

FIG. 1 is a basic block diagram illustrating a battery charging system in accordance with the invention.

FIG. 2 is a flowchart illustrating the logic flow for the battery charging system of the invention.

FIG. 3 is a graph illustrating an example of the DV settings used in the battery charging system of the invention.

FIG. 4 is a graph illustrating an example of the DT settings used in the battery charging system of the invention.

FIG. 5 is a graph illustrating the percent return achieved on a specific set of batteries using the battery charging system of the invention.

FIG. 6 is a flowchart illustrating the initialization of progressive DV/DT in accordance with the battery charging system of the invention.

FIG. 7 is a flowchart illustrating the DV/DT decision flow in accordance with the battery charging system of the invention.

FIG. 8 is a flowchart illustrating the progressive DV/DT termination check in accordance with the battery charging system of the invention.

### DETAILED DESCRIPTION

The present invention will be described with respect to particular embodiments and with reference to certain drawings but the invention is not limited thereto but only by the claims. The drawings described are only schematic and are non-limiting. In the drawings, the size of some of the elements may be exaggerated or distorted and not drawn on scale for illustrative purposes. Where an indefinite or definite article is used when referring to a singular noun, e.g., “a” or “an,” “the,” this includes a plural of that noun unless something else is specifically stated.

As used herein, “state of charge” refers to a range of 0-100 percent that is related to battery discharge amount, and is represented as a percent of capacity used. For a 100 ampere-hour (AH) battery pack a discharge of 10 AH means a state of charge of 90%.

As used herein, “DV/DT” refers to the voltage change in a battery over a period of time during a charge.

As used herein, “DV/DT termination” refers to a battery charge termination method based on the voltage change in a battery over a period of time during a charge, which is further described in U.S. Pat. No. 3,794,905, incorporated herein by reference; when the voltage rise within the specified period of time is less than the allowed DV value, charging is terminated.

As used herein, “progressive DV/DT termination” refers to a battery charge termination method whereby the state of charge of a battery is used to automatically adjust DV/DT to tailor the overcharge amount to the specific needs of the battery.

As used herein, “overcharge” refers to the amount of charge beyond the amount of energy removed from a battery.

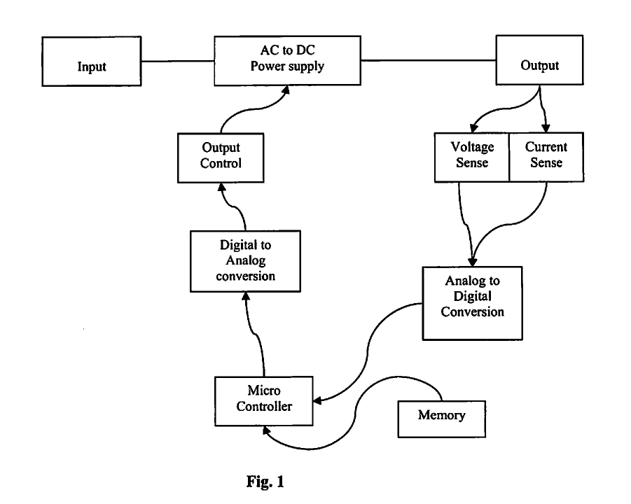

As shown in FIG. 1, in the battery charging system of the invention the AC to DC supply serves as a current source that is controlled by an embedded micro controller via an output control based on voltage and current sense inputs. The decision as to the amount of current and the control to apply to the AC to DC supply is performed by firmware developed for the micro controller. When a charge is performed the firmware will determine the requirements of the charge based on the voltage and current inputs and pre-programmed settings within the firmware. These settings will apply a control signal to the AC to DC supply to achieve the desired resulting current. Though the AC to DC supply is specifically a current source, the control method applied may target control of the final current or voltage on the battery.

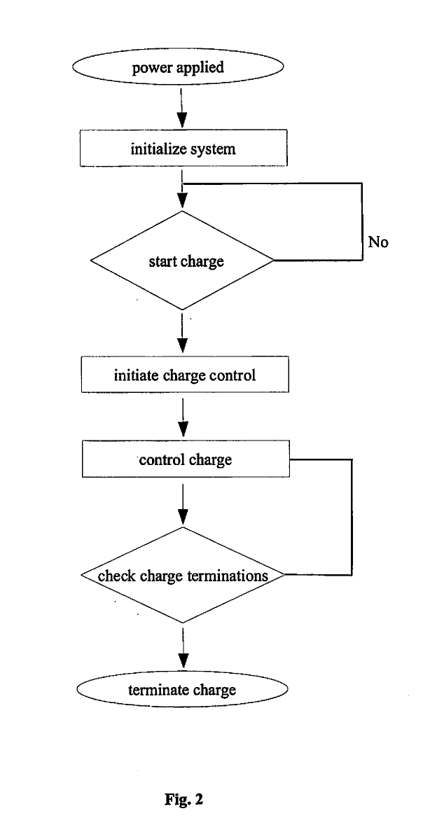

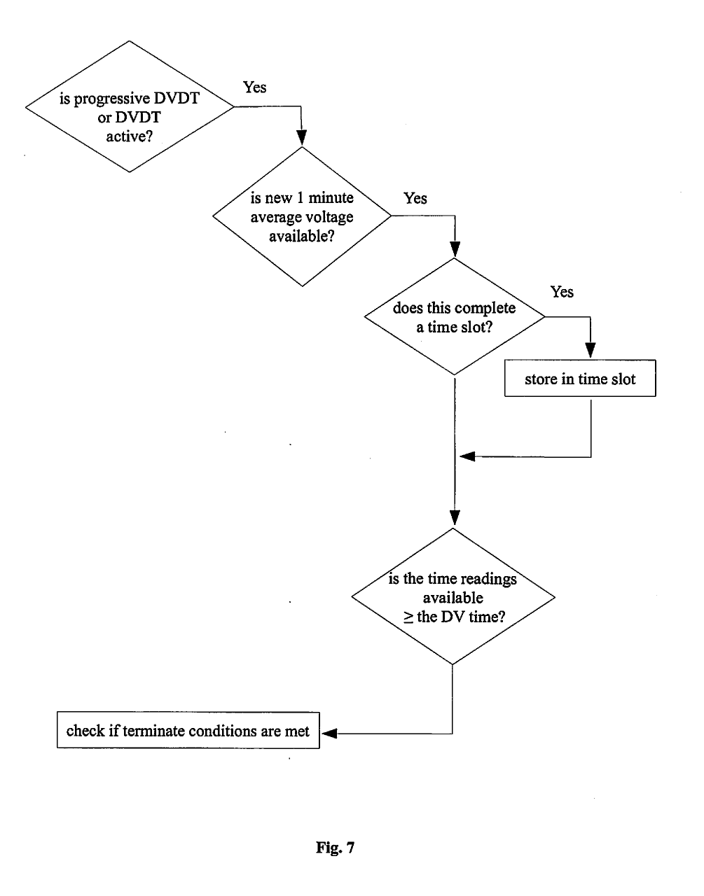

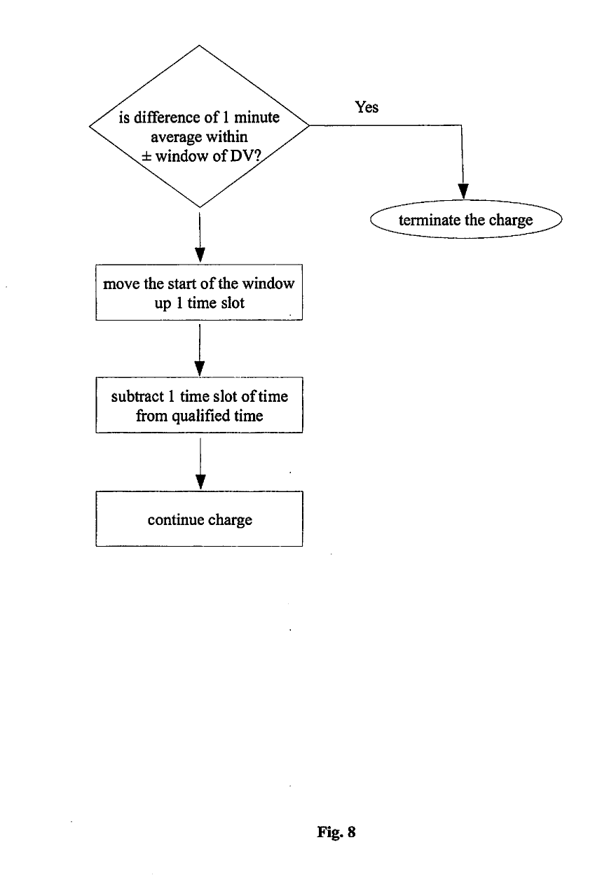

Referring to FIG. 2, the flow chart illustrates the logic flow of the battery charging system of the invention. For purposes of the present invention, the key steps are the “Init charge control” and the “Check charge terminations.” In the “Init charge control” step, the state of charge of the battery is calculated and the applicable DV and DT values are determined. The state of charge calculation uses the voltage of the battery to indicate the percentage of charge present in the battery prior to the start of charge. The state of charge is determined by dividing the battery voltage by the number of cells in the battery. 2.0 VDC per cell is considered fully discharged, and 2.17 VDC per cell is considered fully charged. This inherently takes into account the life cycle of the battery as the fully charged battery will exhibit different voltages at full charge over the life (amp hour sourced) of the battery while not significantly altering the voltage for discharges that represent less than the current capacity of the battery. This allows for the voltage and time components of DV/DT to be set to the numbers that represent a fully discharged battery even when the capacity has been reduced by the life of the battery being consumed. In the “Check charge terminations” step, more particularly outlined in the DV/DT decision flowchart illustrated in FIG. 7 and the progressive DV/DT terminations check flowchart illustrated in FIG. 8, all charge terminations are checked to see if the system needs to terminate the charge. If not, then the charge process continues.

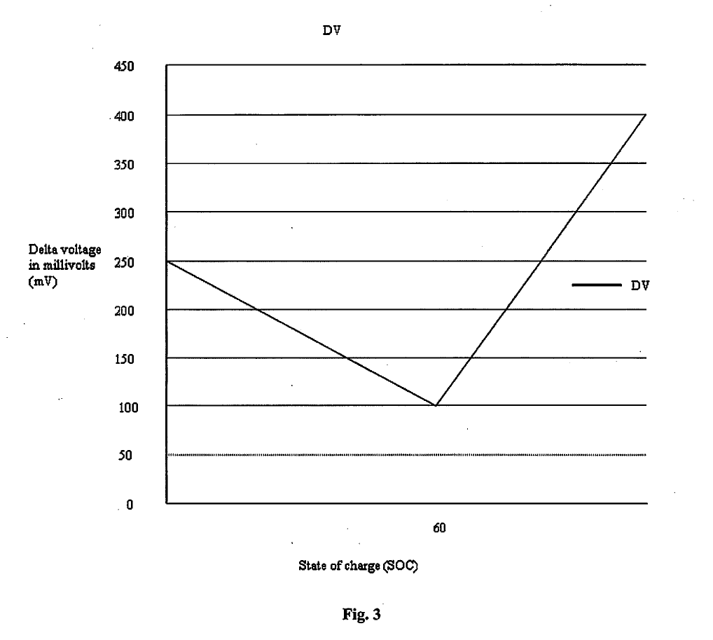

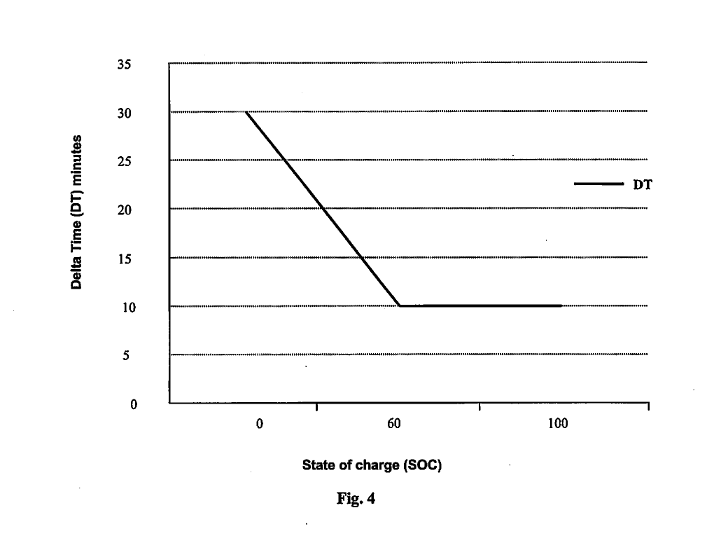

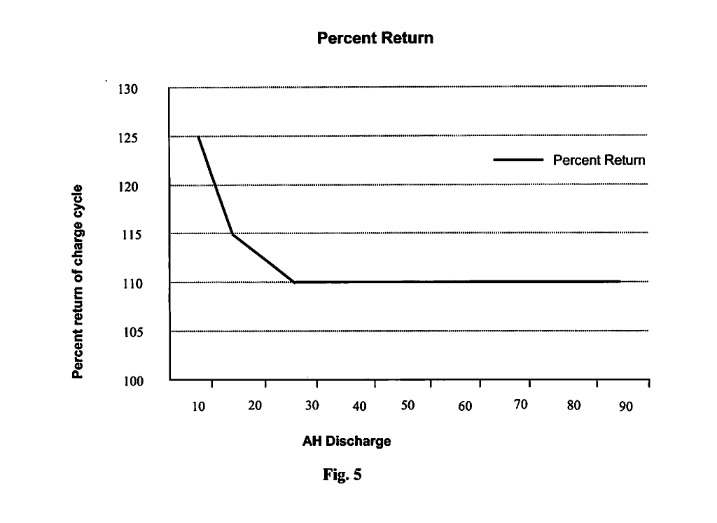

Examples of a particular set of DV and DT values in the settings are graphically illustrated in FIGS. 3 and 4, respectively. All of the settings can be changed as needed to accommodate specific needs in different batteries from a manufacturer. In the examples shown the pivot point is set to 60% state of charge with a pivot DV of 100 mV for a pivot DT of 10 minutes. From the pivot to the minimum DV/DT (100% state of charge) the DV will rise to 400 mV based on the state of charge (from 60 to 100) and the DT component is still 10 minutes, but this could be a different value and it would be applied according to the state of charge. The combination of the settings, the state of charge, and the formula allows the battery charging system to define a tailored solution to the battery vendor requirements. This could be to produce a consistent percent return across all the state of charge values or to produce a specific rise or fall in the percent return on either side of the designated pivot point. FIG. 5 is a graphical illustration of the percent return achieved on a specific set of batteries using the DV and DT settings described in FIGS. 3 and 4, respectively, in the battery charging system of the invention. A flat percent return for state of charges lower than the pivot point while increasing the percent return for the charge cycles for batteries with a higher state of charge (smaller discharge amounts) is seen.

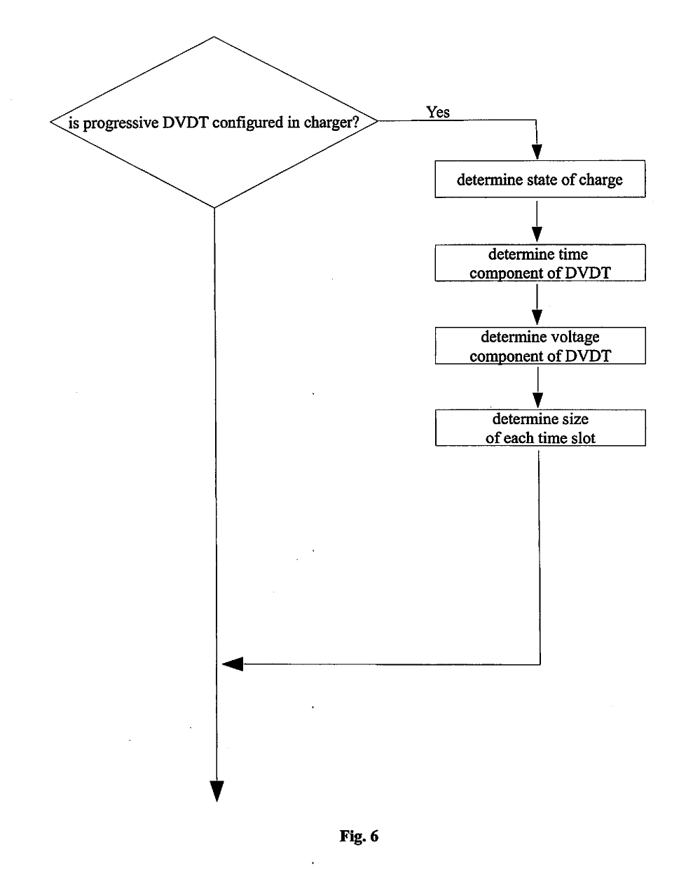

Once the battery charging system of the invention has determined that a charge should be started, progressive DV/DT is initialized, as illustrated in FIG. 6. The state of charge will have been calculated prior to charging as described above. The time and voltage components of DV/DT to be used in the charge termination check (FIG. 2) are determined at this point. The time component utilizes the state of charge and the settings of maximum DT, pivot DT, minimum DT, and the pivot point identified in the DT settings in progressive DV/DT (FIG. 4). The voltage component utilizes the state of charge and the settings of maximum DV, pivot DV, minimum DV, and the pivot point identified in the DV settings in progressive DV/DT (FIG. 3). The time and voltage components can be determined based on which side of the pivot point the state of charge lies on: 100% state of charge to pivot point, or pivot point to 0% state of charge. The methodology utilized for each of the time component and voltage component is a standard slope/intersect formula of y=mx+b. For the time component, if the state of charge is less than the pivot point, then m=(pivot DT−minimum DT)/pivot point, and if the state of charge is greater than or equal to the pivot point, then m=(maximum DT−pivot DT)/(100−pivot point), and b=pivot DT−(m*pivot point). The time to use for DV/DT is (state of charge*m)+b . For the voltage component, if the state of charge is less than the pivot point, then m=(pivot DV−minimum DV)/pivot point, and if the state of charge is greater than or equal to the pivot point, then m=(maximum DV−pivot DV)/(100−pivot point), and b=pivot DV−(m×pivot point). The voltage to use for DV/DT is the the (state of charge*m)+b.

Progressive DV/DT termination can use either a variable number of time slots to allow a slot for each time increment, or a fixed number of slots, in which case the time per slot is fitted to the time component of DV/DT. It also uses a minimum increment of time, such as, for example, 1 minute. The size of the minimum increment can be different with the only effect being the speed of determining the termination. If a fixed number of time slots is used, the time component of DV/DT determined above must be fitted into a fixed number of slots where each slot is at least 1 minute in size (the 1 minute average of the readings). Thus, by way of example, if the time component of DV/DT is determined to be 20 minutes and the number of slots is 15, then each slot represents 2 minutes.

As shown in FIG. 8, the implementation of the time slots is a standard rotating queue or list of slots. This means the slots represent a period of time from the start reference point to the end of the circular queue which is the entry just prior to the start reference point in the queue. When first used, the queue fills from the first slot in the queue until the queue is full. This rotating buffer of readings representing the time component of DV/DT and contain readings for each slot size stored in the location. Once full the queue is filled by returning to the first slot for the new reading, which results in the buffer containing x minutes of averaged voltage readings, where x is the DT component of DV/DT. When a new 1 minute average of the voltage readings is available, the system will determine if this completes a time slot and if so the reading will be stored in the time slot and the time elapsed will be set to the number of slots filled. If the time elapsed, either time slots filled or time slots filled plus the minutes available that did not fulfill a slot, are greater than or equal to the DV time then the termination conditions are checked to determine if they are met. The termination check checks the difference from voltage stored in the start time reference slot to the current voltage reading. If the difference is within the window or lower than the value in the starting slot, then DV/DT is qualified and the charge is terminated. If the difference is greater than the allowed DV window, then the reference slot in the rotating buffer is moved up one slot and the time that is considered complete is reduced by the number of minutes that fulfill one slot.

As established in the prior art, the response of a lead acid battery as it becomes fully charged is indicated by the rate of change in voltage over a defined period of time (DV/DT). The present invention adjusts the DV/DT parameters automatically based on the state of charge in the battery to tailor the overcharge amount to the specific needs of the battery. An overcharge of X minutes produces a variable percentage overcharge and can result in either an undercharge or serious overcharge condition in the battery, which affects the life of the battery. If a charger provides 5 amps for 12 minutes, this represents 1 amp-hour and if the battery discharge was 10 amp-hours, this is 10% overcharge, whereas for a 100 amp-hour discharge, this represents 1%. The ability to tailor the DV/DT time to a specific battery manufacturer allows for designing a specific charge curve that achieves the return desired by the manufacturer, rather than accepting the response tailored to one specific discharge amount (common method of setting DV/DT) and allowing the overcharge/undercharge condition at other discharge levels. The present invention permits the setting of specific information into the charging system to tailor the overcharge amount across all levels of discharge.

One skilled in the art will appreciate that the embodiments provided above are exemplary and in no way limit the present invention.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

The Abstract of the disclosure will allow the reader to quickly ascertain the nature of the technical disclosure. It is submitted with the understanding that it will not be used to interpret or limit the scope or meaning of the following claims.

What is claimed is:

1. A lead-acid battery charging system comprising:
an AC to DC power supply for supplying current to a lead-acid battery; and
an embedded micro controller configured to receive voltage and current information from the battery when it is connected to the power supply, and to control the current supplied to the battery based on the voltage and current information and based on the DV/DT of the battery, wherein the DV/DT has been pre-determined based on the state of charge of the battery, and wherein the micro controller has been programmed with the DV/DT to provide a configured charge return to the battery.

2. A method for controlling the supply of current to a lead-acid battery comprising:
connecting an AC to DC power supply to a lead-acid battery, wherein embedded into the power supply is at least one micro controller configured to receive voltage and current information from the battery when it is connected to the power supply, and to control the current supplied to the battery based on the voltage and current information and based on the DV/DT of the battery, wherein the DV/DT has been pre-determined based on the state of charge of the battery, and wherein the at least one micro controller has been programmed with the DV/DT to provide a configured charge return to the battery.
